(19) United States
(12) Patent Application Publication
(10) Pub. No.: US 2010/0022373 A1
(43) Pub. Date: Jan. 28, 2010

(54) METHOD AND APPARATUS FOR FORMING A PACKAGE

(76) Inventor: Philippe LeBras, Chateauroux (FR)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 12/523,222

(22) PCT Filed: Jan. 15, 2008
(86) PCT No.: PCT/US08/51052

§ 371 Date: Jul. 15, 2009

(30) Foreign Application Priority Data
Jan. 15, 2007 (GB) 0700727.1

(51) Int. Cl. B31B 3/00

(52) U.S. Cl. 493/52

(57) ABSTRACT

A method for forming a package (11) from a carton blank (10) comprising; providing a carton blank (10) having series of panels (12, 14, 16, 18, 20) for forming carton walls in flat collapsed form locating a mandrel (60a, 60b, 62) on an inner surface of a first panel (16) of the carton blank, sequentially folding the series of panels (12, 14, 16, 18, 20) of the carton blank about the mandrel (60a, 60b, 62) whereby forming the carton walls; securing the at least two of the series of panels (12, 20) together to maintain the carton in an assembled form.

### FIELD OF INVENTION

The present invention relates to a method and apparatus for forming a package, more particularly but not exclusively it relates to forming a carton blank about a preformed mould.

### BACKGROUND ART

It is known to assemble cartons from carton blanks prior to insertion of articles to form a package.

It is also well known to partially assemble carton blanks in flat collapsed form prior to insertion of articles or to assemble a carton about a group of articles.

The present invention seeks to provide a method and apparatus for assembling a carton blank into a fully erected state such that the carton may receive articles without requiring a complex alignment process to ensure correct assemble of the package.

### SUMMARY OF INVENTION

According to a first aspect of the present invention there is provided a method for forming a package from a carton blank comprising; providing a carton blank having series of panels for forming carton walls and a keel structure in flat collapsed form, erecting the keel structure from one of the series of panels, locating a mandrel on an surface of said one panel of the carton blank so that it supports the erected keel structure, folding panels of the carton blank adjacent said one panel about the mandrel thereby forming the remainder of the carton walls, securing a pair of panels to the keel structure and to overly the said one panel so that the secured panels and the said one panel are spaced apart by the keel structure and thereby maintaining the carton in an assembled form and removing the mandrels from the set up carton.

Preferably, the mandrel fills the internal volume of the carton.

Preferably, there comprises a plurality of mandrels about which the carton is formed and wherein said keel structure is formed about at least one of said plurality of mandrels.

Preferably, said plurality of mandrels are shaped complementary to one another so as to fill the internal volume of the carton.

Preferably, the method further comprises removing the mandrels from the set up carton.

Preferably, the method further comprises lowering the set up carton, with respect to an article array, onto the array of articles.

Preferably, lowering the set up carton causes deformation of portions of the carton to facilitate entry of portions of the articles into an article retention structure.

An optional feature of the invention comprises ensuring location of the articles within the article retention structure.

Preferably, the method comprises ensuring the correct location of the article is achieved by inserting an alignment tool within an access structure formed in one of the series of panels forming the carton walls.

According to a second aspect of the present invention there is provided an apparatus for forming a package comprising a magazine for supplying of carton blanks, the carton blanks having a series of panels for forming carton walls, and being supplied in a flat collapsed form, a mandrel for assembling a carton by folding the series of panels of the carton blank about the mandrel using a folding device, and a securing means for securing the carton in a set up condition.

Preferably, the apparatus comprises a transfer mechanism for transferring the set up carton to a group of articles and receiving the articles within the carton.

Preferably, the apparatus comprises an alignment tool for ensuring correct alignment of the carton about the article group.

According to a third aspect of the present invention there is provided a method for forming a package from a carton blank comprising;
providing a carton blank having series of panels for forming carton walls in flat collapsed form,
locating a mandrel on an inner surface of a first panel of the carton blank,
sequentially folding the series of panels of the carton blank about the mandrel whereby forming the carton walls;
securing the at least two of the series of panels together to maintain the carton in an assembled form.

### BRIEF DESCRIPTION OF THE DRAWINGS

The preferred embodiment of the present invention will now be described by reference to the accompanying drawings in which;

FIG. 1 is a plan view of a blank for forming a carton,

FIG. 2 is a perspective view illustrating the carton in a partially set up condition,

FIG. 3 is a perspective view of a plurality of mandrels according to the preferred embodiment,

FIG. 4 is a perspective view of a plurality set up carton formed around the mandrels illustrated in FIG. 3,

FIG. 5 is a perspective view of a set up carton illustrating removal of the mandrels of FIG. 3,

FIG. 6 is a side view of the set up carton of the preferred embodiment illustrated partially receiving an array of articles,

FIG. 7 is a side view of a set up carton in which the articles have been received by the carton.

FIG. 8 shows a perspective view of a completed package according to a preferred embodiment of the present invention.

### DETAILED DESCRIPTION OF THE PREFERRED EMBODIMENT OF THE PRESENT INVENTION

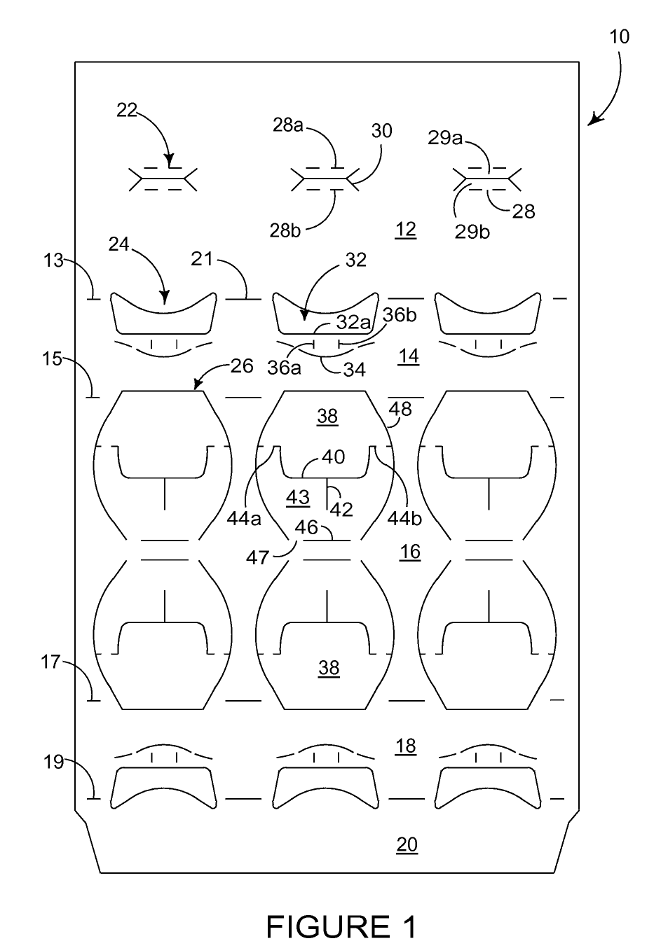

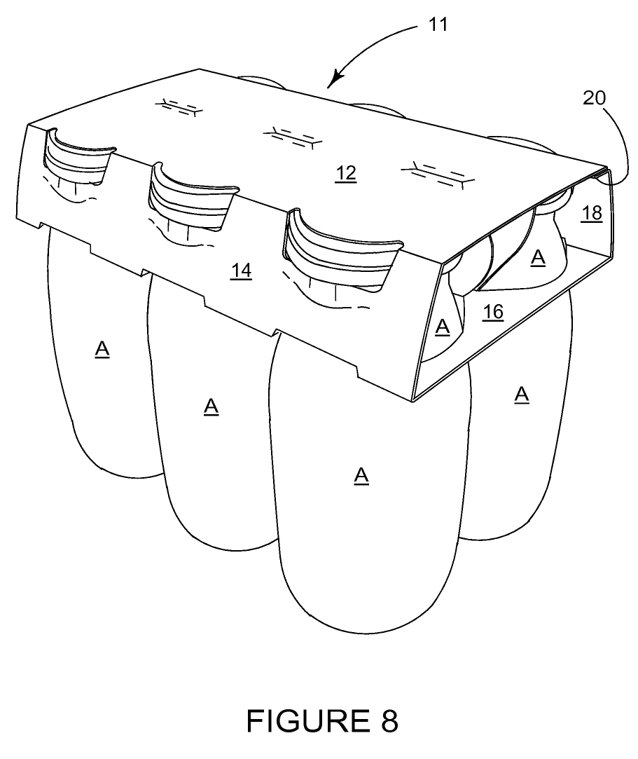

FIG. 1 shows a blank 10 for forming a carton 11, as shown in FIG. 8. The blank 10 comprises a series of main panels 12, 14, 16, 18 and 20 hinged one to the next along fold lines 13, 15, 17 and 19 respectively.

Blank 10 when erected forms a carton 11 of the top gripping style as shown in FIG. 8. It can be seen that carton 11 forms an open ended tubular structure. Fold lines 13, 15, 17 and 19 are defined in part by cut lines 21. Base panel 16 comprises a plurality of engaging elements 26. In the preferred embodiment there are six engaging elements 26.

Each engaging element 26 is substantially the same in construction thereby only one will be described in detail.

The engaging element 26 comprises a securing tab 38, struck in part from a base panel 16 and in part from a side wall panel 14. Engaging element 26 is defined in part by cut line 48 and in part by a fold line 47.

The fold line 47 comprises a cut line 46 to facilitate folding. Securing tab 38 is coupled to an upright member 43, by fold lines 44a and 24b. Fold lines 44a and 44b are disposed near opposed edges of securing tab 38.

Fold lines 44a and 44b are spaced apart by and connected to a U shaped cut line 40. Upright member 43 comprises a cut line 42 which is in touching contact at one end with the U shaped cut line 40. Cut line 42 is disposed perpendicular to fold lines 44a and 44b.

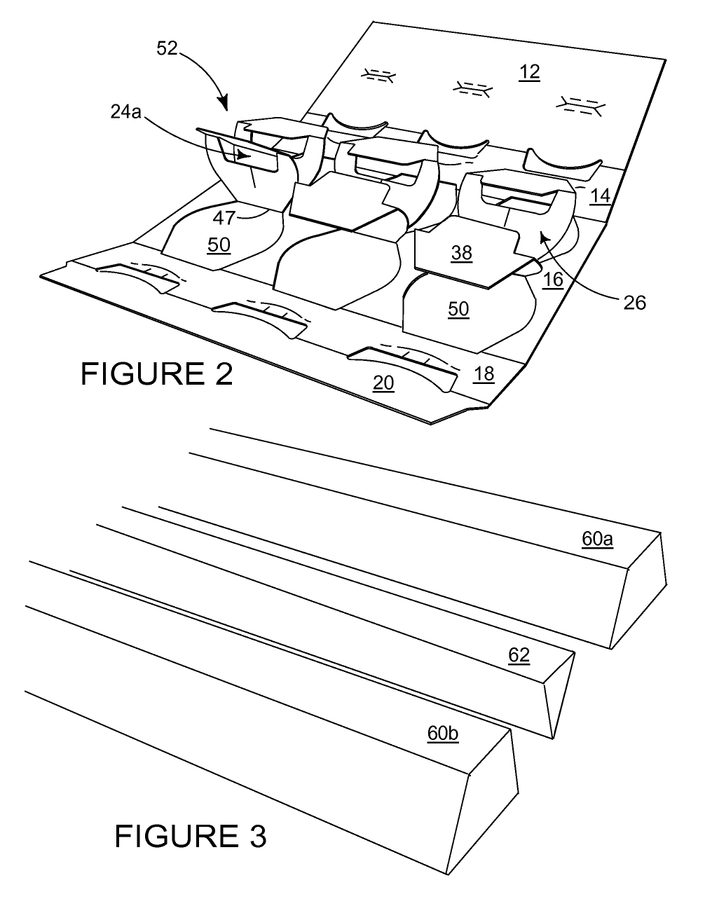

Turning now to FIG. 2, engaging element 26 when displaced out of the plane of base panel 16 defines an aperture 50 which is defined in part by cut line 48 and in part by fold line 47.

The carton 11, in a set up condition, comprises six apertures 50 arranged in a two by three array.

Returning to FIG. 1, blank 10 also comprises a plurality of article engaging structures 24 for engaging articles. In the preferred embodiment there are six article engaging structures 24. The article engaging structures 24 are formed in part in the side wall panels 14, 18 and in part in the top wall panel 12, 20.

There are three article engaging structures 24 formed in side wall panel 14 and top wall panel 12 and three article engaging structures 24 formed in side wall panel 18 and top wall 20. Each article engaging structure 24 is of substantially the same construction therefore only one will be described in further detail.

Article engaging structure 24 comprises an aperture 32 struck in part from side wall panel 14 and in part from top wall panel 12. Aperture 32 comprises an engaging edge 32a.

Engaging edge 32a engages with a protrusion or lip of an article A in a set up carton 11 such that the article A is retained within the carton 11.

A plurality of cut lines 34, 36a, 36b facilitate deformation of a region of the side wall panel 14 proximate to engaging edge 32a.

When the carton 11 is in a set up condition and an article A is received in the article engaging structure 24 the plurality of cut lines 34, 36a, 36b allow the side wall panel 14 proximate the engaging edge 32a to be displaced to facilitate entry of the article A into the article engaging structure 24 and removal of the article A from the article engaging structure 24.

The plurality of cut lines 34, 36a, 36b additionally or alternatively improve retention of the article A with the set up carton 11.

Top wall panel 12 additionally comprises an access structure 22. Access structure 22 comprises a cut line 30, shaped to comprise a Y shaped section at each end.

A pair of cut lines 28a and 28b comprising two distinct cut lines are disposed between the Y shaped end sections. Cut lines 28a and 28b define in part a fold line 28. Fold line 28 and cut line 30 together define a pair of trapezoidal shaped tabs 29a, 29b.

Each access structure 22 is disposed in the top wall panel 12 such that in a set up carton 11 it is in registry with the central region of base wall panel 16 disposed between a pair of apertures 50.

Turning again to FIG. 2, the engaging elements 26 are shown in a partially set up condition.

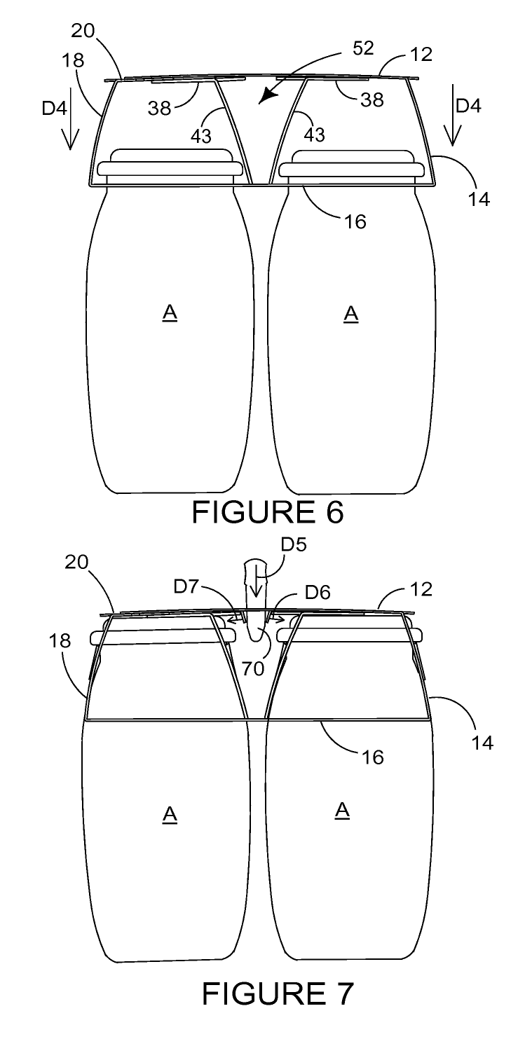

The engaging elements 26 together form a keel structure 52 disposed centrally within the carton 11 as can be seen by reference to FIG. 6.

Upright members 43 in the set up carton 11 are arranged to be disposed at an angle to the base wall panel 16 such that a pair of upright members 43 disposed in back to back relationship form a substantially V shaped keel structure 52.

Securing tabs 38 are folded about fold lines 44a, 44b such that they are substantially parallel to top wall panel 12 in the set up carton. When securing tab 38 is folded out of the plane of upright member 23 the region of securing tab 38 is defined in part by U shaped cut line 40 reveals an aperture 24a which is capable of receiving a portion of an article A. The base of U shaped cut line 43 defines an engaging edge for engaging and retaining an article A received in the aperture 24a. Cut line 42 allows regions of the upright member 43 disposed on either side of it to deform to facilitate entry and exit of a portion of an article A.

Turning now to FIG. 3, there is shown a plurality of mandrels 60a, 60b and 62 which define a mould about which the carton 11 is formed. Mandrels 60a and 60b are elongate members having a substantially trapezoidal cross section. Mandrel 62 is also an elongate member however it is triangular in cross sections. Only one end of the mandrels 60a, 60b and 62 is shown in FIG. 3. The other end, it is envisaged, will be coupled to a packaging machine, perhaps by means of an overhead conveyor.

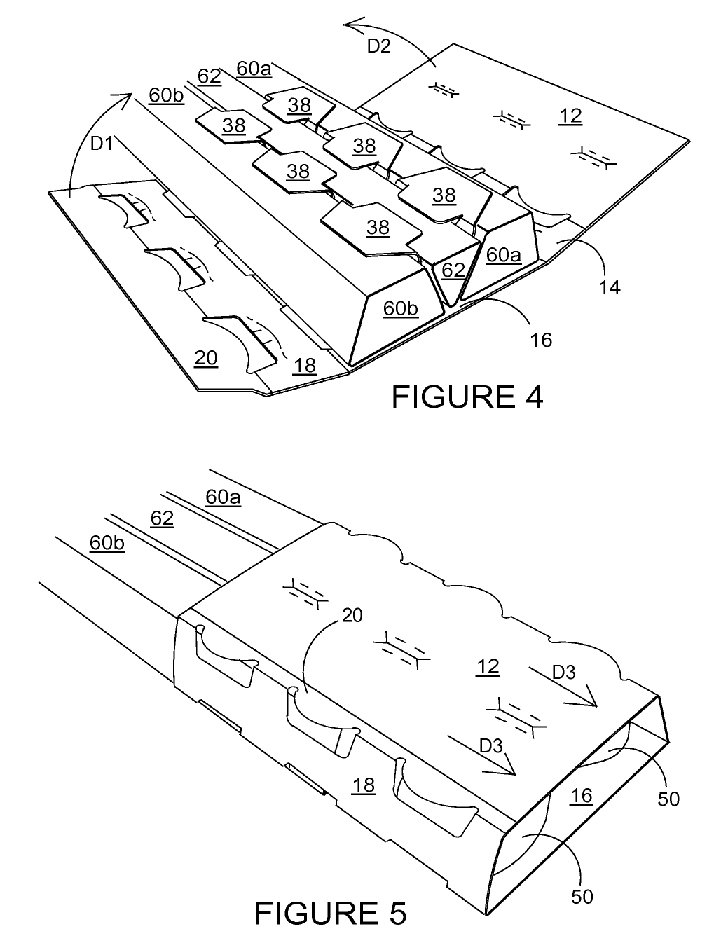

Turning now to FIG. 4, it can be seen that mandrels 60a, 60b and 62 have been placed upon base wall panel 16 of the blank 10.

Triangular mandrel 62 has been placed such that it is disposed between each pair of back to back upright members 43 and having the regions of securing tab 38 defined in part by U shaped cut line 40 disposed in overlapping relationship with an upper face of the triangular mandrel 62.

In this way the triangular mandrel 62 can be utilised to correctly align the keel structure 52 whilst the carton 11 is constructed.

Trapezoidal mandrels 60a, 60b are placed on either side of triangular mandrel 62 such that respective upright members 43 are disposed between triangular mandrels 62 and one of the trapezoidal mandrels 60a or 60b. Together mandrels 60a, 60b and 62 when combined together to define the shape of the carton 11. It will be appreciated that the mandrels 60a, 60b and 62 fill the internal valve of the carton 11 and therefor provide a rigid structure against which the blank 10 can be formed into the carton 11. Blank 10 can be folded about mandrels 60a, 60b, 62 such that top panel wall 12 and securing panel 20 are disposed above the mandrels 60a, 60b, 62. Adhesive or other securing means known in the art can be used to secure the top wall panel 12 to the securing panel 20. Trapezoidal mandrels 60a, 60b also assist correct alignment of the keel structure 52.

Once the carton 11 has been formed about the mandrels 60a, 60b and 62 they can be removed from the carton 11 by sliding the carton 11 with respect to the mandrels 60a, 60b and 62, as illustrated by direction arrows D3

Once the mandrels 60a, 60b and 62 have been removed the carton 11 is capable of receiving an array of articles A arranged to match the array of apertures 50 formed in the base panel 16.

FIG. 6 illustrates a side view of a set up carton 11 as it receives an array of articles A.

Carton 11 is brought down over the array of articles by movement of the carton 11 vertically downward as indicated by direction arrows D4. Portions of each of the articles A are received respectively in each of the apertures 50.

FIG. 7 illustrates insertion of an alignment tool 70 into the carton 11 via the access structure 22, along the direction indicated by direction arrow D5.

As a consequence trapezoidal tabs 29a and 29b are deflected in the direction indicated by arrows D6 and D7 respectively.

Alignment tool 70 can be inserted into the set up carton 11 to apply a downward force to a central region of base wall panel 16 disposed between the apertures 50 in order to ensure that the articles A each engage with their respective apertures 24a formed in the keel structure 52. Thus ensuring that each of the articles A received in the carton 11 are securely engaged by both aperture 24 and article engaging structure 24.

It is envisaged that three alignment tools 70 will be provided such that each pair of articles A can be engaged with a respective aperture 24a simultaneously. However it will be appreciated by those skilled in the art that the alignment process may be carried out sequentially by a single alignment tool 70.

It will also be appreciated by those skilled in the art that the present invention can be adapted to be used in a continuous line packaging machine. That the mandrels 60a, 60b and 62 may be provided for example, by guide rails along which the carton 11 travels as the carton 11 is set up or by fingers inserted into each carton for the duration of the assembly process wherein these fingers are coupled to a conveyor means for conveying the carton 11 through the packaging assembly process.

Alignment tools 70 may be provided on an overhead conveyor system or by means of a star wheel located above a conveyor line on which the packages are formed.

It will further be appreciated by those skilled in the art that the terms “top”, “base”, “side”, “end”, “inner”, “outer”, “upper” and “lower” with respect to the panels of the carton or carton blank are relative terms and that the carton formed from the blank may be orientated as necessary or as desired. It will be recognised that rather than the top wall being formed from composite panels, the carton blank may be arranged whereby some other walls such as a side wall be composite.

It should also be understood that numerous changes may be made within the scope of the present invention. For example there may be any number of mandrels and they may take any shape necessary to form the desired carton necessary to assemble the cartons.

Furthermore, the invention is not limited to top gripping style carriers but may be employed in wrap around or fully enclosed cartons.

It will be appreciated still further that the present invention may be implemented in a continuous line packaging machine, in a robotics system, or other automated machine systems, or may be implemented in a hand assembly environment.

1. A method for forming a package from a carton blank comprising; providing a carton blank having series of panels for forming carton walls and a keel structure in flat collapsed form, erecting the keel structure from one of the series of panels, locating a mandrel on a surface of said one panel of the carton blank so that it supports the erected keel structure, folding panels of the carton blank adjacent said one panel about the mandrel thereby forming the remainder of the carton walls, securing a pair of panels to the keel structure and to overly the said one panel so that the secured panels and the said one panel are spaced apart by the keel structure and thereby maintaining the carton in an assembled form and removing the mandrels from the set up carton.

2. A method according to claim 1 wherein the mandrel fills the internal volume of the carton.

3. A method according to claim 2 wherein there comprises a plurality of mandrels about which the carton is formed and wherein said keel structure is formed about at least one of said plurality of mandrels.

4. A method according to claim 3 wherein said plurality of mandrels are shaped complementary to one another so as to fill the internal volume of the carton.

5. A method for forming a package according to claim 1 further comprising lowering the set up carton, with respect to an article array, onto the array of articles.

6. A method for forming a package according to claim 1 wherein lowering the set up carton causes deformation of portions of the carton to facilitate entry of portions of the articles into an article retention structure.

7. A method for forming a package according to claim 5, further comprising ensuring location of the articles within the article retention structure.

8. A method for forming a package according to claim 7 wherein ensuring the correct location of the article is achieved by inserting an alignment tool within an access structure formed in one of the series of panels forming the carton walls.

9. A carton formed using the method described in claim 1.

10. A package formed using the method described in claim 1.

11. An apparatus for forming a package comprising a magazine for supplying carton blanks, the carton blanks having a series of panels for forming carton walls, and being supplied in flat collapsed form, a mandrel for assembling a carton by folding the series of panels of the carton blank about the mandrel using a folding device, and a securing means for securing the carton in a set up condition.

12. An apparatus for forming a package according to claim 11 comprising a transfer mechanism for transferring the set up carton to a group of articles and receiving the articles within the carton.

13. An apparatus for forming a package according to claim 11 comprising an alignment tool for ensuring correct alignment of the carton about the article group.

14. A method for forming a package from a carton blank comprising;
providing a carton blank having series of panels for forming carton walls in flat collapsed form
locating a mandrel on an inner surface of a first panel of the carton blank,
sequentially folding the series of panels of the carton blank about the mandrel whereby forming the carton walls;
securing the at least two of the series of panels together to maintain the carton in an assembled form.
